(19) United States
(12) Patent Application Publication
(10) Pub. No.: US 2015/0304099 A1
(43) Pub. Date: Oct. 22, 2015

(54) Inter-Signal Delay Processing Method and Device

(71) Applicant: ZTE CORPORATION, Shenzhen, Guangdong (CN)

(72) Inventor: Ying MENG, Shenzhen (CN)

(21) Appl. No.: 14/653,587

(22) PCT Filed: Aug. 26, 2013
(86) PCT No.: PCT/CN2013/082315

§ 371 Date: Jun. 18, 2015

(30) Foreign Application Priority Data
Dec. 18, 2012 (CN) 201210551976.9

(51) Int. Cl. H04L 7/00

(52) U.S. Cl. CPC H04L 7/0075; H04L 7/0016

(57) ABSTRACT

Disclosed are an intra-signal delay processing method and device. The method includes: a bit error rate of each path of serial digital signal of a plurality of paths of serial digital signals is determined at N sampling clocks, wherein the each sampling clock in the N sampling clocks is a sum of a recovered clock and N interpolation phases, and the N interpolation phases are within one preset clock unit; an interpolation phase corresponding to the each path of serial digital signal is determined according to the bit error rate, wherein the sampling clock position is within one preset clock unit; and a clock of the each path of serial digital signal is adjust by using the interpolation phase corresponding to the each path of serial digital signal. The disclosure improves the reliability of data transmission.

### TECHNICAL FIELD

The disclosure relates to the field of communications, including e.g., an inter-signal delay processing method and device.

### BACKGROUND

Network convergence is a main driving force for developing the 100G and more than 100G network, and the increase of the convergence capacity can cope with the increasing service requirements.

Currently, a 40G optical transmission system mainly adopts a self-correlation receiving mode, which limits the application of polarization multiplexing technology. In order to improve transmission performance, a 100G optical transmission system adopts a Polarization Multiplexed-Differential Quadrature Reference Phase Shift Keying (PM-DQPSK for short) modulation mode. The transmitting end is divided into two parts, the polarization multiplexing part and the DQPSK modulation part, and the receiving end is divided into two parts, the polarization demultiplexing part and the Differential Quadrature Reference Phase Shift Keying (PM-DQPSK for short) demodulation part.

FIG. 1 is a schematic diagram of polarization demultiplexing and demodulation of a receiving end in a 100G optical transmission system, which is completed by coherent reception and digital signal processing together. After the coherent reception, the 100G optical signal generates I path and Q path signals (Ix, Ty, Qx and Qy) in polarization states X and Y, which is completed the photovoltaic conversion; then digital signals are generated via the ADC conversion and are sent to a plurality of paths of serdes (serial-to-parallel converter), which are completed analog-to-digital conversion and serial-to-parallel conversion; and then the parallel data is demultiplexed and demodulated.

In the above-mentioned implementation solution, the demultiplexing and demodulation process requires the strict alignment on the I path and Q path data in the polarization states X and Y as well as in the same polarization state. However, there may be a inter-symbol delay between the data sent, after the I path and Q path signals in the polarization states X and Y generated via the coherent reception goes through the ADC sampling, to the plurality of paths of serdes may, which results in an incorrect processing result of the demultiplexing and demodulation algorithm.

In view of the problem in the related art that inter-signal delay results in an incorrect data demultiplexing result, no effective solution has been proposed so far.

### SUMMARY

In view of the problem that the inter-signal delay results in an incorrect data demultiplexing result, an inter-signal delay processing method and device are provided in the disclosure so as to solve the problem.

According to one aspect of the disclosure, an inter-signal delay processing method is provided, comprising: determining bit error rates of each path of serial digital signal of a plurality of paths of serial digital signals at N sampling clocks, wherein each sampling clock of the N sampling clocks is a sum of a recovered clock and N interpolation phases, the N interpolation phases are within one preset clock unit, and N is a positive integer greater than 1; determining an interpolation phase corresponding to the each path of serial digital signal according to the bit error rates; and adjusting a clock of the each path of serial digital signal by using the interpolation phase corresponding to the each path of serial digital signal.

According to an embodiment of the disclosure, determining the interpolation phase corresponding to the each path of serial digital signal according to the bit error rates comprises: determining a sampling clock corresponding to a minimum value of the bit error rates, as the interpolation phase corresponding to the each path of serial digital signal.

According to an embodiment of the disclosure, after adjusting the clock of the each path of serial digital signal by using the interpolation phase corresponding to the each path of serial digital signal, the method further comprises: performing serial-to-parallel conversion on the plurality of paths of serial digital signals. According to an embodiment of the disclosure, the N interpolation phases are uniformly distributed within the preset clock unit.

According to an embodiment of the disclosure, the recovered clock is a clock which is determined according to a preset reference clock and a homologous clock when an Analog to Digital Converter (ADC) outputs data.

According to another aspect of the disclosure, an inter-signal delay processing device, comprising: a first determining component, configured to determine bit error rates of each path of serial digital signal of a plurality of paths of serial digital signals at N sampling clocks, wherein each sampling clock of the N sampling clocks is a sum of a recovered clock and N interpolation phases, the N interpolation phases are within one preset clock unit, and N is a positive integer greater than 1; a second determining component, configured to determine an interpolation phase corresponding to the each path of serial digital signal according to the bit error rates; and an adjusting component, configured to adjust a clock of the each serial digital signal by using the interpolation phase corresponding to the each path of serial digital signal.

According to an embodiment of the disclosure, the second determining component is configured to determine a sampling clock corresponding to a minimum value of the bit error rates, as the interpolation phase corresponding to the each path of serial digital signal.

According to an embodiment of the disclosure, the device further comprises: a conversion component, configured to perform serial-to-parallel conversion on the plurality of paths of serial digital signals.

According to an embodiment of the disclosure, the N interpolation phases are uniformly distributed within the preset clock unit.

According to an embodiment of the disclosure, the recovered clock is a clock which is determined according to a preset reference clock and a homologous clock when an Analog to Digital Converter (ADC) outputs data.

In the disclosure, bit error rates of each path of serial digital signal of a plurality of paths of serial digital signals are determined at N sampling clocks, wherein each sampling clock in the N sampling clocks is the sum of a recovered clock and N interpolation phases, the N interpolation phases are within one preset clock unit; an interpolation phase corresponding to each path of the serial digital signal is determined according to the bit error rates; the clock of each path of the serial digital signal is adjusted by using the interpolation phase corresponding to each path of the serial digital signal, so that it leads to a higher accuracy of a clock of each path of serial digital signals, thus solving the problem that inter-signal delay results in an incorrect data demultiplexing result and further achieving the effect of improving data decoding accuracy rate.

### BRIEF DESCRIPTION OF THE DRAWINGS

Drawings, provided for further understanding of the disclosure and forming a part of the specification, are used to explain the disclosure together with embodiments of the disclosure rather than to limit the disclosure. In the drawings:

FIG. 1 is a schematic diagram of a polarization demultiplexing and demodulation implementation of a receiving end in a 100G optical transmission system according to the related art.

FIG. 2 is a flowchart of an inter-signal delay processing method according to an embodiment of the disclosure;

FIG. 3 is a structure diagram of an inter-signal delay processing device according to an embodiment of the disclosure;

FIG. 4 is a structure diagram of an inter-signal delay processing device according to an example embodiment of the disclosure;

FIG. 5 is a schematic diagram of an inter-signal delay processing method according to an example embodiment of the disclosure;

FIG. 6 is schematic diagram I of a relationship between a clock phase and a bit error rate according to an embodiment of the disclosure;

FIG. 7 is schematic diagram II of a relationship between a clock phase and a bit error rate according to an embodiment of the disclosure;

FIG. 8 is a schematic diagram of a delay alignment method of multiple paths of data of a 100 gigabit Ethernet (GE for short) service after coherent reception according to an embodiment of the disclosure; and

FIG. 9 is a schematic diagram of a delay alignment method of multiple paths of data of an optical transform unit (OUT for short) 4 service after coherent reception according to an embodiment of the disclosure.

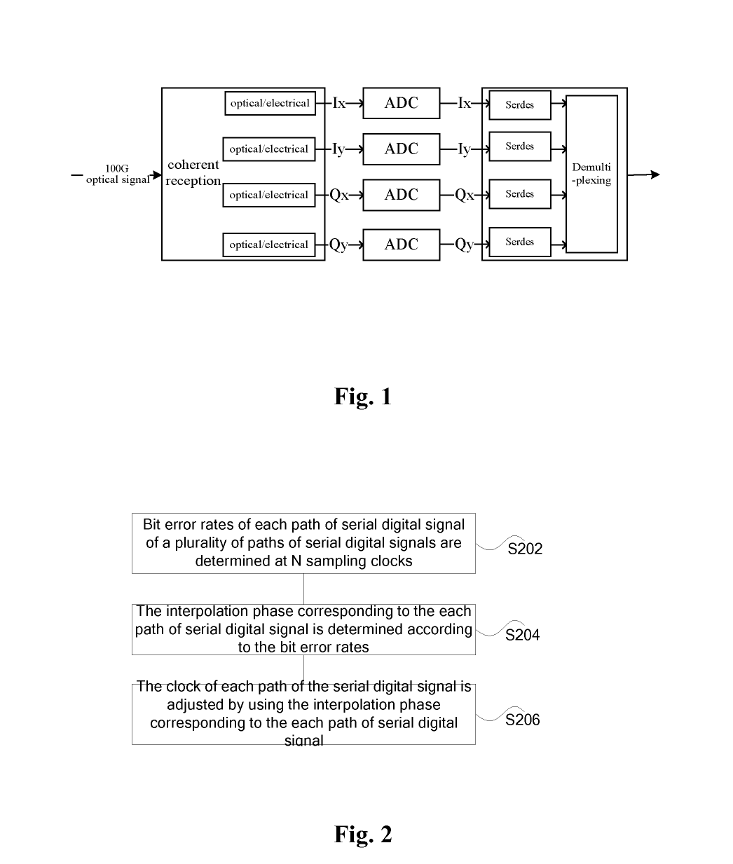

### DETAILED DESCRIPTION OF THE EMBODIMENTS

The disclosure is described below with reference to the accompanying drawings and embodiments in detail. Note that, the embodiments of the present application and the features of the embodiments can be combined with each other if there is no conflict.

An inter-signal delay processing method is provided in the embodiment of the disclosure. FIG. 2 is a flowchart of an inter-signal delay processing method according to an embodiment of the disclosure, comprising the following steps S202-S206.

Step S202: Bit error rates of each path of serial digital signal of a plurality of paths of serial digital signals at N sampling clocks are determined, wherein each sampling clock of the N sampling clocks is a sum of a recovered clock and N interpolation phases, the N interpolation phases are within one preset clock unit, and N is a positive integer greater than 1.

Step S204: An interpolation phase corresponding to the each path of serial digital signal is determined according to the bit error rates.

Step S206: A clock of the each path of serial digital signal is adjusted by using the interpolation phase corresponding to the each path of serial digital signal.

By means of the above-mentioned steps, the bit error rates of the each path of serial digital signal of the plurality of paths of serial digital signals are determined at N sampling clocks, the interpolation phase corresponding to the path of the serial digital signals is determined according to the bit error rates, and then the clock of the each path of the serial signal is adjusted by using the interpolation phase, the correction on the inter-symbol non-integer delay caused in a serial digital signal transmission process is achieved, thus improving the accuracy rate of digital signal transmission and meeting the requirements of a subsequent demultiplexing and demodulation algorithm.

In the implementation, when the bit error rate is lower, the sampling clock corresponding to the lower bit error rate is selected as a new sampling clock. In order to improve the accuracy of the clock, the sampling clock corresponding to the minimum value in the bit error rate can be determined as the sampling clock corresponding to each path of the serial digital signals. In other words, the sampling clock corresponding to the bit error rate with the minimum value, is determined as the interpolation phase corresponding to the each path of serial digital signal.

As an example embodiment, after step S206, the serial-to-parallel conversion can be further performed on the plurality of paths of serial digital signals. In the example embodiment, after recovery, the serial digital signals converts into the parallel data for transmission, improving the efficiency of data transmission.

In the implementation, the N interpolation phases can be distributed in many ways within the preset clock unit, for example, arithmetic distribution and random distribution, etc. In order to improve the accuracy for determining the interpolation phase, the N interpolation phases can be uniformly distributed within the preset clock unit.

As an example embodiment, the recovered clock is a clock which is determined according to a preset reference clock and a homologous clock when an ADC outputs data.

It should be noted that the steps shown in the flowchart of the drawings can be executed, for example, in a computer system with a set of instructions executable by a computer, in addition, a logic order is shown in the flowchart, but the shown or described steps can be executed in a different order under some conditions.

In another embodiment, a kind of inter-signal delay processing software is further provided, and the software is used to execute the technical solutions described in the above-mentioned embodiments and example embodiments.

In another embodiment, a storage medium is further provided, and the storage medium has stored the above-mentioned inter-signal delay processing software, and the storage medium comprises but is not limited to optical disk, floppy disk, hard disk, erasable storage, and the like.

An inter-signal delay processing device is further provided in the embodiment of the disclosure, and the inter-signal delay processing device can be used to achieve the above-mentioned inter-signal delay processing method and example embodiments, thereby needing no further description for the embodiments that have been described. Components involved in the inter-signal delay processing device are described below. As used in the following, the term “component” can achieve a combination with a predefined function of software and/or hardware. Although the system and method described in the following embodiments are achieved better by using software, hardware or a combination of software and hardware is achievable and is conceived.

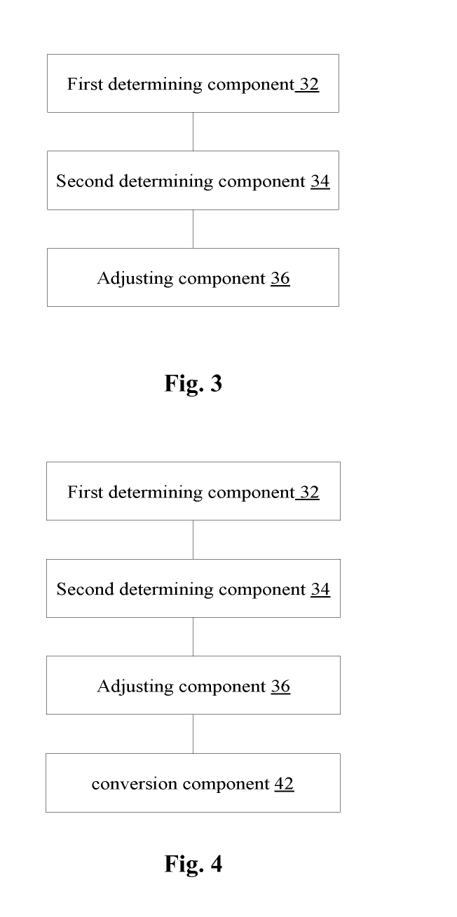

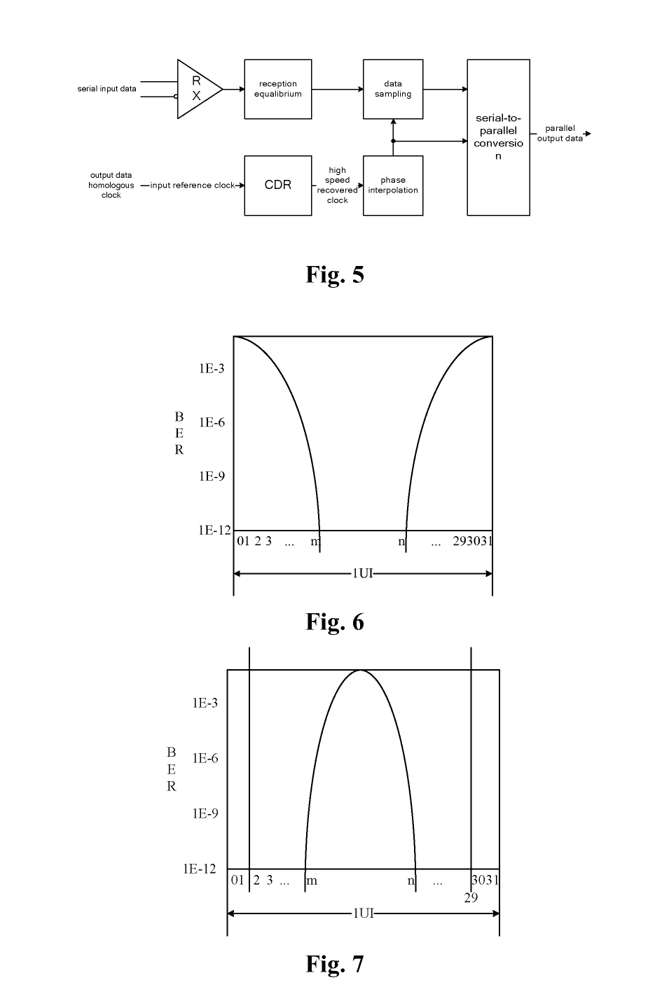

FIG. 3 is a structure diagram of an inter-signal delay processing device according to an embodiment of the disclosure. As shown in FIG. 3, the device comprises: a first determining component 32, a second determining component 34 and an adjusting component 36, and the above-mentioned structure is described in detail below.

The first determining component 32 is configured to determine bit error rates of each path of serial digital signal of a plurality of paths of serial digital signals at N sampling clocks, wherein each sampling clock of the N sampling clocks is a sum of a recovered clock and N interpolation phases, the N interpolation phases are within one preset clock unit, and N is a positive integer greater than 1. The second determining component 34, connected to the first determining component 32, is configured to determine an interpolation phase corresponding to the each path of serial digital signal according to the bit error rates determined by the first determining component 32, wherein the sampling clock position is within one preset clock unit. The adjusting component 36, connected to the second determining component 34, is configured to adjust the clock of the each path of serial digital signal by using the interpolation phase corresponding to the each path of serial digital signal that is determined by the second determining component 34.

In an optional manner, the second determining component 34 is configured to determine the sampling clock corresponding to the bit error rate with the minimum value as the interpolation phase corresponding to the each path of serial digital signal.

In an optional manner, the N interpolation phases are uniformly distributed within the preset clock unit.

In an optional manner, the recovered clock is the clock which is determined according to a preset reference clock and a homologous clock when an ADC outputs data.

FIG. 4 is a structure diagram of an inter-signal delay processing device according to an example embodiment of the disclosure. As shown in FIG. 4, the device further comprises a conversion component 42, configured to perform serial-to-parallel conversion on the plurality of paths of serial digital signals.

The description below is in combination with optional embodiments, and the following optional embodiments are combined with the above-mentioned embodiments and example embodiments.

### Optional Embodiment 1

A method for adjusting inter-symbol non-integer delay is provided in the optional embodiment, and the method includes the following steps S302-S310.

Step S302: A plurality of paths of electrical signals generated by the coherent reception are sent to ADCs for sampling, and each path of the electrical signal corresponds to a path of the ADCs.

Step S304: The plurality of paths of digital signals sampled by the ADCs are sent to a multi-channel (serdes) for data serial-to-parallel conversion and clock recovery.

Step S306: A Digital Clock Recovery (CDR for short) of the serdes is compulsively locked on a reference clock which is homologous with the clock when the ADC outputs data. The CDR of the serdes recovers two clocks: a high speed recovered clock, of which the clock frequency is a half of the rate of the serdes, is used for sampling the serial input data of the serdes; and a low speed recovered clock, of which the clock frequency is related to the rate of the serdes and the bit wide setting for the parallel data, is used for performing subsequent logical processing on parallel output data of the serdes.

Step S308: The inter-symbol non-integer delay generated in the transmission link of sending the ADC sampling data to the serdes is compensated by dynamically adjusting a high speed recovered clock sampling position. Phase interpolation is performed on the high speed clock recovered by the CDR of each serdes channel; the sampling position of the high speed clock at which the data is serially input is dynamically adjusted within a clock unit; the different sampling positions correspond to different clock phases; and the adjustment accuracy is related to the number of clock phases. After the phase interpolation, the more the number of clock phases is, the higher the adjustment accuracy is; conversely, the less the number of clock phases is, the lower the adjustment accuracy is.

Step S310: The plurality of paths of ADCs simultaneously send Pseudo-Random Binary Sequence (PRBS) codes; the CDR high speed recovered clock sampling position is respectively adjusted in each serdes channel; PRBS code bit error detection is performed on the corresponding serdes parallel output data; and the best sampling phase is determined by detecting the bit error rates.

In the step, different number of clock phases after the phase interpolation can be selected. In the present example embodiment, 32 clock phases after the phase interpolation is taken as an example to describe how to adjust the sampling position and choose the best sampling phase, comprising the following steps S1-S4.

Step S1: as shown in FIG. 6, a sampling clock unit (UI) is divided into 32 phases, and the serial numbers thereof are 0, 1, 2, . . . , 30, and 31.

Step S2: the bit error rate 1E-12 is selected as a judgement criterion; when it is at the current clock phase, the bit error rate is lower than 1E-12, the transmission link is considered to be better; otherwise, when the bit error rate is higher than 1E-12, the transmission link is considered to be worse.

Step S3: the bit error rate continuously changes as the adjustment of the sampling clock phase. According to that the positions between the initial sampling clock phase and the data, there are two cases of the best sampling position.

The first case: as shown in FIG. 6, the bit error rate at the initial phase 0 is very high, and the bit error rate decreases as the increase of the sampling phase; when the sampling phase arrives at phase m, the bit error rate decreases to 1E-12; with the continuous increase of the sampling phase, the bit error rate further decreases; when the bit error rate is close to 0, the clock phase value is the best sampling phase; then as the increase of the sampling phase value, the bit error rate begins to rise; when it arrives at a phase n, the bit error rate arrives at 1E-12 again; and finally, as the sampling phase continues to go up to 31, the bit error rate constantly increases. A stabilization section [m:n] of the link can be obtained from a corresponding relationship between the bit error rate and the clock phase, and the best sampling phase is selected as (m+n)/2 from this section.

The second case: as shown in FIG. 7, the bit error rate at the initial phase 0 is very low; as the increase of the sampling phase, when it arrives at the phase m, the bit error rate goes up to 1E-12, and then the bit error rate continues to go up to a very high value and decreases as the increase of the sampling phase; and when it arrives at the phase n, the bit error rate arrives at 1E-12 again, and then continues to decrease. In this case, the best sampling phase is (m+32+n)/2.

Therefore, the adjustment process comprises traversing 32 clock phases, finding the stabilization section of the link by detecting the bit error rates and further calculating the best sampling phase value.

Step S4: after the non-integer delay generated when a plurality of paths of data go through the sampling transmission and arrives at the serdes is adjusted, the symbol shift process is performed on the parallel output data of each path of the serdes so as to achieve the purpose of integral delay adjustment. A demultiplexing and demodulation algorithm process is performed on each adjusted path of data.

By means of the above-mentioned steps, the adjustment of the inter-symbol non-integer delay generated when the plurality of paths of high speed signals go through the sampling transmission and arrive at the serial-to-parallel converter (e.g., serdes) can be achieved, so as to ensure that the plurality of paths of data used for processing the subsequent algorithm is strictly aligned (for example, the inter-symbol non-integer delay generated when I path and Q path data in different polarization states and in the same polarization state in a 100G optical transmission system go through the ADC sampling transmission and arrive at the serdes meets the requirements of a subsequent demultiplexing and demodulation algorithm). It should be noted that the inter-symbol delay includes integral delay and non-integer delay, and the integral delay in the related art is adjusted by shifting in the digital process, but the non-integer delay cannot be solved by the shift process.

### Optional Embodiment 2

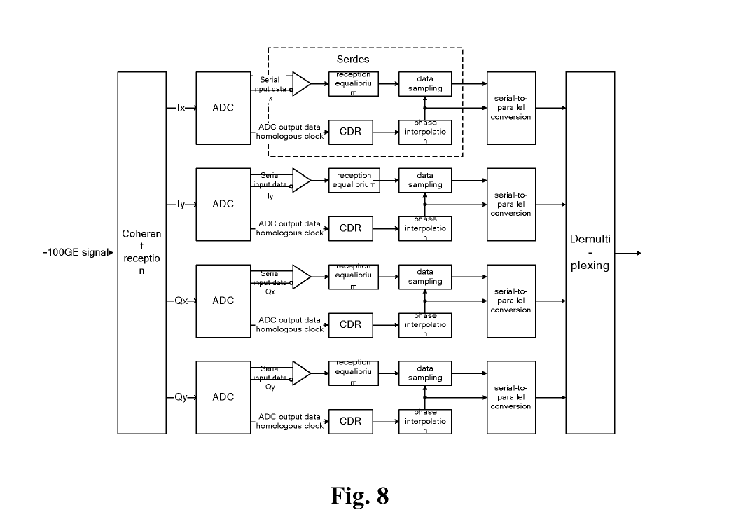

A non-integer delay alignment method of multiple paths of data of a 100 GE service after coherent reception is provided in the optional embodiment of the disclosure. FIG. 8 is a schematic diagram of a delay alignment method of multiple paths of data of a 100 GE service after coherent reception according to an embodiment of the disclosure. As shown in FIG. 8, I path and Q path signals in polarization states X and Y generated via coherent reception of a 100GE signal are respectively sent to an ADC for 1.5 times of sampling. Each path of the signal sampled by the ADC is sent to a multi-channel serial-to-parallel converter for conversion and recovery. In the process, the CDR of the serdes is compulsively locked on a reference clock which is homologous with the clock when the ADC outputs data. The phase interpolation is performed on the high speed clock recovered by the CDR of each serdes channel; that is to say, the sampling position of the high speed clock for the serial inputting data is adjusted within a clock unit; the different sampling positions are regarded as the different clock phases; and the adjustment range is 32 clock phases. A plurality of paths of ADCs simultaneously send PRBS codes; the sampling phase of the CDR high speed recovered clock is respectively adjusted in each serdes channel ; PRBS code bit error detection is performed on the data output parallelly by the corresponding serdes; the best sampling phase value is determined by detecting the bit error rates; and then the four paths of signals are respectively recovered, and then are demultiplexed after serial-to-parallel conversion. The following steps S802-S812 are used to describe the above-mentioned process in detail below.

Step S802: The I path and Q path signals in the polarization states X and Y generated via coherent reception of a 100GE service signal are respectively sent to an ADC for 1.5 times of sampling.

Step S804: The digital signals sampled by the ADC are sent to a multi-channel serdes for data serial-to-parallel conversion and clock recovery, and the rate of the serdes is 2.62G Step S806: The CDR of the serdes is compulsively locked on a reference clock which is homologous with the clock when the ADC outputs data. The CDR of the serdes recovers two clocks: a high speed recovered clock, of which the clock frequency is a half of the rate of the serdes, is used for sampling serial input data of the serdes; and a low speed recovered clock, of which the clock frequency is related to the rate of the serdes and the bit wide setting for the parallel data, is used for performing subsequent logical processing on parallel output data of the serdes.

Step S808: The phase interpolation is performed on the high speed clock recovered by the CDR of each serdes channel; that is to say, the sampling position of the high speed clock at which the data is serially input is adjusted within a clock unit; the different sampling positions are regarded as different clock phases; and the adjustment range is 32 clock phases.

Step S810: The plurality of paths of ADCs simultaneously send the PRBS codes; the CDR high speed recovered clock sampling phase is respectively adjusted in each serdes channel; the PRBS code bit error detection is performed on the corresponding serdes parallel output data; and the best sampling phase value is determined by detecting the bit error rates.

Step S812: After the non-integer delay generated when the plurality of paths of data go through the sampling transmission and arrive at the serdes is adjusted, the symbol shift process is performed on the parallel output data of each path of the serdes so as to achieve the purpose of integral delay adjustment. A demultiplexing and demodulation algorithm process is performed on each adjusted path of data.

### Optional Embodiment 3

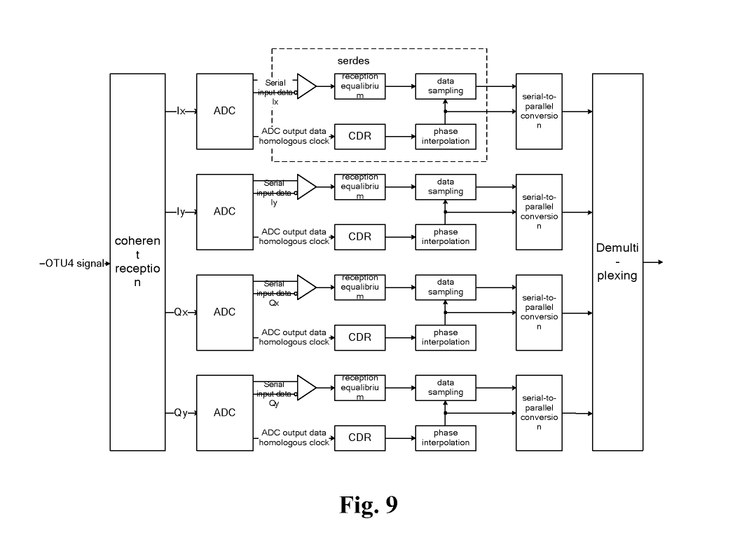

A delay alignment method of multiple paths of data of an OTU4 service after coherent reception is provided in the optional embodiment of the disclosure. FIG. 9 is a flowchart of a delay alignment method of multiple paths of data of an OTU4 service after coherent reception according to the optional embodiment of the disclosure. As shown in FIG. 9, the I path and Q path signals in polarization states X and Y generated via the coherent reception of an OTU4 service signal are respectively sent to an ADC for 1.5 times of sampling. Each path of the signal sampled by the ADC is sent to a multi-channel serial-to-parallel converter for conversion and recovery. In the process, the CDR of the serdes is compulsively locked on a reference clock which is homologous with the clock when the ADC outputs data. The phase interpolation is performed on the high speed clock recovered by the CDR of each serdes channel; that is to say, the sampling position of the high speed clock for the serial inputting data is adjusted within a clock unit; the different sampling positions are regarded as the different clock phases; and the adjustment range is 32 clock phases. A plurality of paths of ADCs simultaneously send PRBS codes; the sampling phase of he CDR high speed recovered clock is respectively adjusted in each serdes channel; the PRBS code bit error detection is performed on the data output parallelly by the corresponding serdes; the best sampling phase value is determined by detecting the bit error rates; and then the four paths of signals are respectively recovered, and then are demultiplexed after serial-to-parallel conversion. The following steps S902-S912 are used to describe the above-mentioned process in detail below.

Step S902: The I path and Q path signals in the polarization states X and Y generated via coherent reception of an OTU4 service signal are respectively sent to an ADC for 1.5 times of sampling.

Step S904: The digital signals sampled by the ADC are sent to a multi-channel serdes for data serial-to-parallel conversion and clock recovery, and the rate of the serdes is 2.62G.

Step S906: The CDR of the serdes is compulsively locked on a reference clock which is homologous with the clock when the ADC outputs data. The CDR of the serdes recovers two clocks: a high speed recovered clock, of which the clock frequency is a half of the rate of the serdes, is used for sampling serial input data of the serdes; and a low speed recovered clock, of which the clock frequency is related to the rate of the serdes and the bit wide setting for the parallel data, is used for performing subsequent logical processing on parallel output data of the serdes.

Step S908: The phase interpolation is performed on the high speed clock recovered by the CDR of each serdes channel; that is to say, the sampling position of the high speed clock at which the data is serially input is adjusted within a clock unit; the different sampling positions are regarded as different clock phases; and the adjustment range is 32 clock phases.

Step S910: The plurality of paths of ADCs simultaneously send the PRBS codes; the CDR high speed recovered clock sampling phase is respectively adjusted in each serdes channel; the PRBS code bit error detection is performed on the corresponding serdes parallel output data; and the best sampling phase value is determined by detecting the bit error rates.

Step S912: After the non-integer delay generated when the plurality of paths of data go through the sampling transmission and arrive at the serdes is adjusted, the symbol shift process is performed on the parallel output data of each path of the serdes so as to achieve the purpose of integral delay adjustment. A demultiplexing and demodulation algorithm process is performed on each adjusted path of data.

In the above-mentioned embodiments, an inter-signal delay processing method and device are provided, wherein the bit error rates of the each path of serial digital signal of the plurality of paths of serial digital signals are determined at N sampling clocks; the interpolation phase corresponding to the path of the serial digital signal is determined according to the bit error rates, and then the clock of the path of the serial digital signal is adjusted by using the interpolation phase. The correction of inter-symbol non-integer delay caused in a serial digital signal transmission process is achieved, thus improving the accuracy rate of digital signal transmission and meeting the requirements of a subsequent demultiplexing and demodulation algorithm. It should be noted that these technical effects are not involved in all the above-mentioned embodiments, some technical effects can only be achieved by some example embodiments.

Obviously, those skilled in the art shall understand that the above-mentioned components and steps of the disclosure can be realized by using general purpose calculating device, can be integrated in one calculating device or distributed on a network which consists of a plurality of calculating devices. Alternatively, the components and the steps of the disclosure can be realized by using the executable program code of the calculating device. Consequently, they can be stored in the storing device and executed by the calculating device, or they are made into integrated circuit component respectively, or a plurality of components or steps thereof are made into one integrated circuit component. In this way, the disclosure is not restricted to any particular hardware and software combination.

The descriptions above are only the preferable embodiment of the disclosure, which are not used to restrict the disclosure, for those skilled in the art, the disclosure may have various changes and variations. Any modification, equivalent replacement, or improvement made within the spirit and principle of the disclosure shall all fall within the protection scope of the disclosure.

1. An inter-signal delay processing method, comprising:
determining bit error rates of each path of serial digital signal of a plurality of paths of serial digital signals at N sampling clocks, wherein each sampling clock of the N sampling clocks is a sum of a recovered clock and N interpolation phases, the N interpolation phases are within one preset clock unit, and N is a positive integer greater than 1;
determining an interpolation phase corresponding to the each path of serial digital signal according to the bit error rates; and
adjusting a clock of the each path of serial digital signal by using the interpolation phase corresponding to the each path of serial digital signal.

2. The method according to claim 1, wherein determining the interpolation phase corresponding to the each path of serial digital signal according to the bit error rates comprises:
determining a sampling clock corresponding to a minimum value of the bit error rates, as the interpolation phase corresponding to the each path of serial digital signal.

3. The method according to claim 1, wherein after adjusting the clock of the each path of serial digital signal by using the interpolation phase corresponding to the each path of serial digital signal, the method further comprises:
performing serial-to-parallel conversion on the plurality of paths of the serial digital signals.

4. The method according to claim 1, wherein the N interpolation phases are uniformly distributed within the preset clock unit.

5. The method according to claim 1, wherein the recovered clock is a clock which is determined according to a preset reference clock and a homologous clock when an Analog to Digital Converter (ADC) outputs data.

6. An inter-signal delay processing device, comprising:
a first determining component, configured to determine bit error rates of each path of serial digital signal of a plurality of paths of serial digital signals at N sampling clocks, wherein each sampling clock of the N sampling clocks is a sum of a recovered clock and N interpolation phases, the N interpolation phases are within one preset clock unit, and N is a positive integer greater than 1;
a second determining component, configured to determine an interpolation phase corresponding to the each path of serial digital signal according to the bit error rates; and
an adjusting component, configured to adjust a clock of the each serial digital signal by using the interpolation phase corresponding to the each path of serial digital signal.

7. The device according to claim 6, wherein the second determining component is configured to determine a sampling clock corresponding to a minimum value of the bit error rates, as the interpolation phase corresponding to the each path of serial digital signal.

8. The device according to claim 6, wherein the device further comprises:
a conversion component, configured to perform serial-to-parallel conversion on the plurality of paths of serial digital signals.

9. The device according to claim 6, wherein the N interpolation phases are uniformly distributed within the preset clock unit.

10. The device according to claim 6, wherein the recovered clock is a clock which is determined according to a preset reference clock and a homologous clock when an Analog to Digital Converter (ADC) outputs data.

11. The method according to claim 2, wherein the N interpolation phases are uniformly distributed within the preset clock unit.

12. The method according to claim 3, wherein the N interpolation phases are uniformly distributed within the preset clock unit.

13. The method according to claim 2, wherein the recovered clock is a clock which is determined according to a preset reference clock and a homologous clock when an Analog to Digital Converter (ADC) outputs data.

14. The method according to claim 3, wherein the recovered clock is a clock which is determined according to a preset reference clock and a homologous clock when an Analog to Digital Converter (ADC) outputs data.

15. The device according to claim 7, wherein the N interpolation phases are uniformly distributed within the preset clock unit.

16. The device according to claim 8, wherein the N interpolation phases are uniformly distributed within the preset clock unit.

17. The device according to claim 6, wherein the recovered clock is a clock which is determined according to a preset reference clock and a homologous clock when an Analog to Digital Converter (ADC) outputs data.

18. The device according to claim 6, wherein the recovered clock is a clock which is determined according to a preset reference clock and a homologous clock when an Analog to Digital Converter (ADC) outputs data.
